(19) United States
(12) Patent Application Publication
(10) Pub. No.: US 2009/0205254 A1
(43) Pub. Date: Aug. 20, 2009

(54) Method And System For Converting A Methane Gas To A Liquid Fuel

(76) Inventors: Zhonghua John Zhu, Brisbane (AU); Gaoqing Max Lu, Brisbane (AU); Gregory Solomon, Cottesloe (AU)

Correspondence Address: STEPHEN A. GRATTON, 2764 South Braun Way, Lakewood, CO, 80228, US

(21) Appl. No.: 12/030,970

(22) Filed: Feb. 14, 2008

(51) Int. Cl. C10L 3/00; B01J 19/00

(52) U.S. Cl. 48/127.7; 48/127.9

(57) ABSTRACT

A method for converting a methane gas to liquid fuel forms a non-thermal plasma with radicals and directs the plasma over a catalyst to convert the radicals to higher hydrocarbons in liquid form. The method can be performed in a reactor such as a microwave plasma reactor, or a pulsed corona discharge plasma reactor. A system for performing the method includes a methane gas source, a reactant gas source, a reactor and a catalyst.

### FIELD

This application relates generally to the production of alternative fuels, and particularly to a method and system for converting a methane gas, such as natural gas or bio-gas, to a liquid fuel suitable for use as an alternative fuel.

### BACKGROUND

Natural gas (NG) is a gaseous fossil fuel which is typically found in oil fields, natural gas fields, coal beds and marine sediments. Natural gas typically includes methane as a primary constituent, but can also include other hydrocarbons such as ethane, propane, butane and pentane. Bio-gases, which are produced by the decay of organic material, can also include methane, carbon dioxide and other hydrocarbons as well.

In the art two separate catalytic processes are typically required to convert a gas containing methane to a liquid fuel. These processes include: a syngas process wherein a synthetic gas (a mixture of carbon monoxide and hydrogen) is produced; and then conversion of the synthesis gas to a synthetic fuel by the Fischer-Tropsch (FT) conversion process.

The syngas process is typically performed using a catalyst such as Ni or a noble metal by the following reactions.

CH₄+H₂O→3H₂+CO H₂₉₈=206 kJ/mol (1)

2CH₄+O₂→2CO+4H₂ H₂₉₈=−71 kJ/mol (2)

CO₂+CH₄→2CO+2H₂ H₂₉₈=247 kJ/mol (3)

During the syngas process, reaction (1) requires a large reactor, a high energy consumption and a high H₂/CO product ratio. Reaction (2) (partial oxidation) is exothermic, and can be performed with a smaller reactor. However, heat management with reaction (2) is difficult, requiring a large heat exchanger which occupies a large area. Reaction (3) needs very high energy due to the stability of CO₂. A combination of reaction (2) with reaction (1) or (3) may be used to balance the heat load and shrink the heat exchanger. Coke formation and metal catalyst dusting are also concerning factors during the syngas production.

During the Fischer-Tropsch (FT) conversion process, the reactions are normally catalyzed by Co, Fe or noble metal catalysts. Exemplary reactions include:

Paraffins: (2n+1)H₂+nCO→CₙH₂ₙ₊₂+n H₂O; (4)

Olefins: 2nH₂+nCO→CₙH₂ₙ+nH₂O (5)

Methanol: 2nH₂+nCO→nCH₃OH (6)

Higher Alcohol: nCO+2nH₂→CₙH₂ₙ₊₁OH+(n−1)H₂O (7)

During the Fischer-Tropsch (FT) conversion process, the selectivity for the product is poor. Normally, C₅ to C₂₀ are desirable products, but these reactions produce large quantities of by-products including C₁-C₄ and products over C₂₀. In addition, stability is poor due to the highly exothermic nature of the reactions. In practice, high pressure is required to improve the production of liquid fuels from synthetic gases thus costing extra energy. Coke formation is also an issue during the Fischer-Tropsch (FT) conversion process. In order to improve the reactions, research has been conducted on optimization of the catalyst/support system, and on optimization of the reactor design and operations. However, this research has met with limited success.

These disadvantages have prevented the economic exploitation of conventional methane gas to liquid technology for over 70 years. In addition, the large physical size of the equipment required for a conventional (FT) conversion process makes it unsuitable for use with stranded gases. For example, stranded gases are located in remote locations, or offshore, making pipeline transport difficult, and on site (FT) conversion impractical. A new technology, which can convert methane gases to liquid more effectively and economically, in a smaller space, is thus desired in the art.

The foregoing examples of the related art and limitations related therewith are intended to be illustrative and not exclusive. Other limitations of the related art will become apparent to those of skills in the art upon a reading of the specification and a study of the drawings. Similarly, the following embodiments and aspects thereof are described and illustrated in conjunction with a method and system, which are meant to be exemplary and illustrative, not limiting in scope.

### SUMMARY

A method and a system for converting a methane gas, such as natural gas, to a liquid fuel utilizes a plasma-catalyst hybrid technology in which a non-thermal plasma is used to produce radicals which couple on the surface of a catalyst into hydrocarbons in liquid form.

The method can include the steps of: providing a reactor having a reaction chamber; providing a flow of methane gas and a flow of a reactant gas into the reaction chamber; providing a catalyst in the reaction chamber; producing a non-thermal plasma in the reaction chamber to convert the methane gas and the reactant gas into radicals; directing the radicals over the catalyst to couple the radicals into hydrocarbons in liquid form; and controlling production of the radicals and coupling of the radicals into the hydrocarbons by controlling the flow rate of the methane gas, the flow rate of the reactant gas, a forward power of the plasma, and a frequency of the plasma. The method can be performed continuously in a single process in a single reactor, rather than in two separate processes as with a conventional syngas process in combination with a (FT) conversion process. In addition, the method produces liquid fuels at lower temperatures, produces no coking, and can be performed at remote locations using a small scale reactor.

A system for converting a methane gas to a liquid fuel includes a methane gas source configured to provide a methane gas flow; a reactant gas source configured to provide a reactant gas flow; a reactor connected to the methane gas source and the reactant gas source configured to form a non-thermal plasma and produce radicals; and a catalyst configured to contact the radicals to produce reactions for coupling the radicals into hydrocarbons in liquid form.

### BRIEF DESCRIPTION OF THE DRAWINGS

Exemplary embodiments are illustrated in the referenced figures of the drawings. It is intended that the embodiments and the figures disclosed herein are to be considered illustrative rather than limiting.

FIG. 1 is a flow diagram illustrating steps in a method for producing a liquid fuel;

FIG. 2A is a schematic diagram of a microwave plasma reactor suitable for performing the method of FIGS. 1A and 1B;

FIG. 2B is a schematic diagram of a pulsed corona discharge plasma reactor suitable for performing the method of FIGS. 1A and 1B; and

FIG. 3 is a schematic diagram of a system for performing the method of FIGS. 1A and 1B.

### DETAILED DESCRIPTION OF THE PREFERRED EMBODIMENTS

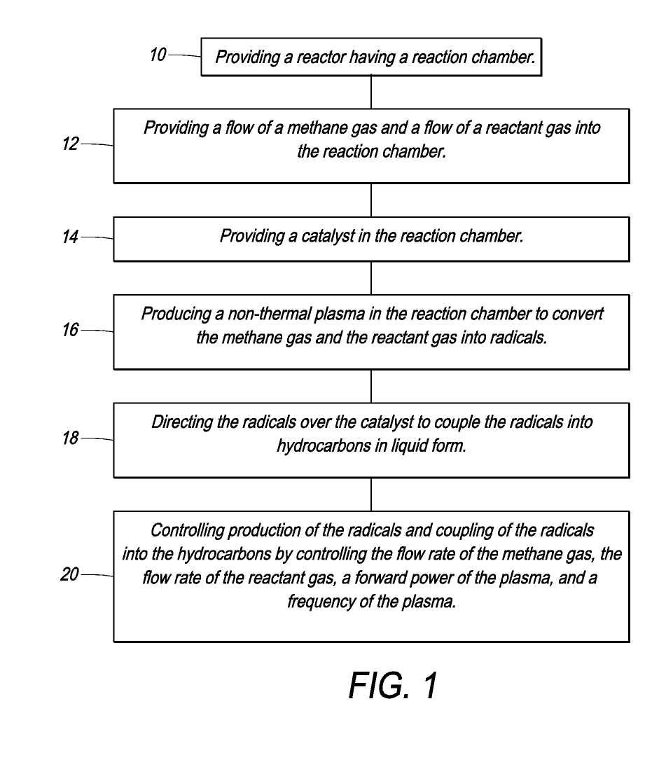

Referring to FIG. 1, broad steps in a method for converting a methane gas to a liquid fuel are illustrated. These steps can include:

Step 10—Providing a reactor having a reaction chamber.

Step 12—Providing a flow of a methane gas and a flow of a reactant gas into the reaction chamber.

Step 14—Providing a catalyst in the reaction chamber.

Step 16—Producing a non-thermal plasma in the reaction chamber to convert the methane gas and the reactant gas into radicals.

Step 18—Directing the radicals over the catalyst to couple the radicals into hydrocarbons in liquid form.

Step 20—Controlling production of the radicals and coupling of the radicals into the hydrocarbons by controlling the flow rate of the methane gas, the flow rate of the reactant gas, a forward power of the plasma, and a frequency of the plasma.

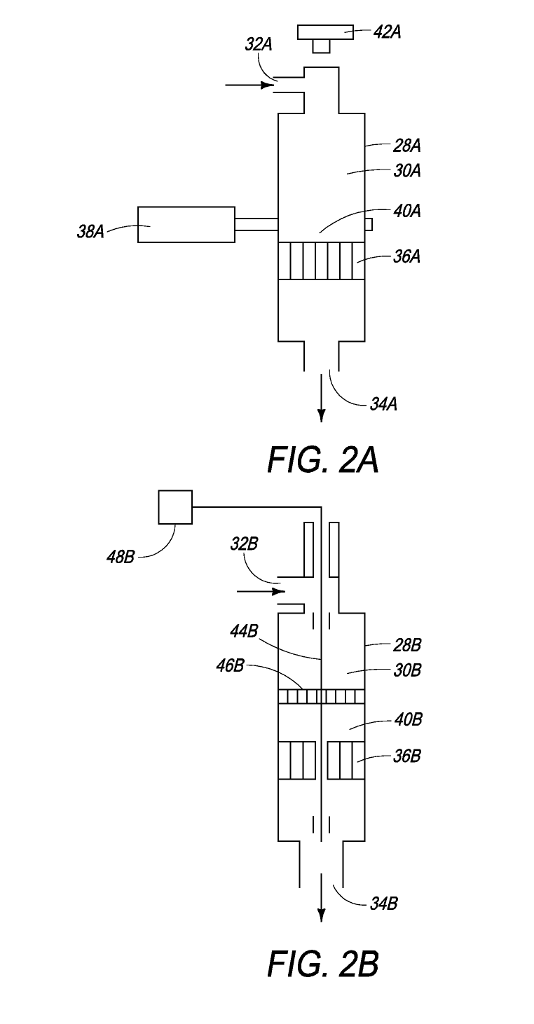

With respect to Step 10 (providing a reactor), FIGS. 2A-2B illustrate exemplary reactors that can be used to perform the method outlined in FIGS. 1A and 1B. As shown in FIG. 2A, a microwave plasma reactor 28A includes a reaction chamber 30A having a gas inlet 32A, and a gas and liquid outlet 34A. The microwave plasma reactor 28A also includes a catalyst 36A in the reaction chamber 30A and a microwave generator 38A. The walls of the microwave plasma reactor 28A are made of a microwave transparent material such that the gases in the reaction chamber 30A can be irradiated by microwave energy to form the plasma and radicals in a plasma zone 40A. The catalyst 36A is located downstream of the plasma zone 40A such that the radicals produced by the plasma are directed through the catalyst 36A and couple to form the hydrocarbons in liquid form, which exit through the gas and liquid outlet 34A. The unreacted gases also exit through the outlet 34A, and are recycled back through the gas inlet 32A to the reaction chamber 30A. The microwave generator 38A can be configured to operate at a single frequency (e.g., 2.45 GHz) or to operate over a range of frequencies (e.g., 0.9 GHz to 18 GHz). The microwave plasma reactor 28A also includes an infrared temperature sensor 42A configured to measure the temperature of the catalyst 36A.

As shown in FIG. 2B, a pulsed corona discharge plasma reactor 28B includes a reaction chamber 30B having a gas inlet 32B, and a gas and liquid outlet 34B. The pulsed corona discharge plasma reactor 28B also includes a catalyst 36B in the reaction chamber 30B, a corona wire 44B and a filter 46B. The pulsed corona discharge plasma reactor 28B also includes a pulsed power supply 48B coupled to the corona wire 44B configured to initiate and terminate a pulsed corona for forming plasma and radicals in a plasma zone 40B. The catalyst 36B is located downstream of the plasma zone 40B, such that the radicals produced by the plasma are directed through the catalyst 36B, and couple to form the hydrocarbons in liquid form, which exit through the gas and liquid outlet 34B. The unreacted gases also exit through the outlet 34A, and are recycled back through the gas inlet 32A to the reaction chamber 30A. The pulsed corona discharge plasma reactor 28B is particularly attractive for industrial implementation because it can use the same wire-plate electrode arrangement as in electrostatic precipitators.

With respect to Step 12 (providing a flow of methane gas), the methane gas can be in the form of pure methane gas. Alternately, the methane gas can be in the form of natural gas obtained from a “fossil fuel” deposit. Natural gas is typically about 90+% methane, along with small amounts of ethane, propane, higher hydrocarbons, and “inerts” like carbon dioxide or nitrogen. As another alternative, the methane gas can be in the form a bio-gas made from organic material, such as organic waste. In addition, the methane gas can be supplied from a tank (or a pipeline) at a selected temperature and pressure. Preferably, the methane gas is provided at about room temperature (20 to 25° C.), and at about atmospheric pressure (1 atmosphere). Further, the methane gas can be provided at a selected flow rate which would be dependant on the size of the reactor 28A-28B (FIGS. 2A-2B).

Also with respect to Step 12 (providing a flow of a reactant gas), the reactant gases can include CO₂, H₂O, O₂ and combinations thereof. The reactant gas can be selected based on the desired composition of the liquid hydrocarbons and fuels. The ratio of the methane gas to the reactant gas (e.g., CH₄/CO₂, CH₄/ H₂O, CH₄/O₂) can also be selected based on the desired composition of the hydrocarbons and fuels in liquid form. The reactant gas can be combined with the methane gas prior to delivery into the reaction chamber 30A-30B (FIGS. 2A-2B), or can be delivered separately from the methane gas and combined in the reaction chamber 30A-30B (FIGS. 2A-2B).

With respect to Step 14 (providing a catalyst in the reaction chamber), the catalyst 36A-36B (FIGS. 2A-2B) can be selected based on the composition of the radicals. Suitable radicals can include CₓH_{y}* radicals to be further described. The catalyst can also be selected, prepared and dispersed to optimize coupling of the hydrocarbons in liquid form from the radicals. In the previously described two step method (syngas with Fischer-Tropsch (FT)), the choice of catalyst is largely determined by the synthesis gas feed composition. Due to a high water-gas-shift activity, iron catalysts are preferred for (FT) synthesis with coal derived syngas (H₂/CO=0.5-0.7). For natural gas derived syngas (H₂/CO=1.6-2.2) and high single pass conversions, cobalt-based catalysts are the preferred choice. However, by operating at low conversions, the use of iron catalysts is still a viable option for natural gas conversion to liquid fuels and chemicals. Accordingly, either iron-based catalysts or cobalt-based catalysts can be used to perform the present method.

Iron-based catalysts can be prepared in bulk form. For example, an iron-based catalyst can be prepared by precipitation, with the high area oxide bound by silica gel and also promoted with alkali. With a cobalt-based catalyst, cobalt is much more expensive, so that it is important that the minimum amount be used without sacrificing activity. This can be achieved by obtaining a high dispersion of the Co on a suitable high surface area support such as Al₂O₃ or SiO₂. All catalysts can be reduced with hydrogen to convert oxides to metals. Cobalt surface atoms show high activity and C₅₊ selectivity. Oxygen atoms in CO co-reactants are predominately removed as H₂O on cobalt-based catalysts. Commercial practice of the present method requires that cobalt-based catalysts can withstand long-term use at high CO concentrations, during which water concentrations approach saturation levels and may even condense with catalyst support pores.

Promoters, such as catalyst and support modifiers, can also be used to increase the dispersion of the clusters, improve attrition resistance, or electronically modify the active metal site. In this regard, a number of different metal oxide promoters can be incorporated to increase dispersion and/or improve attrition resistance. These modifiers, which can be introduced by impregnation and calcination, can include Ru, Pt, Zr, La, Cu, Zn and K. Due to its high resistance to attrition in a continuously stirred tank reactor or slurry bubble column reactor, and its ability to stabilize a small cluster size, Al₂O₃ is a particularly suitable support for cobalt-based catalysts. SiO₂, TiO₂, ZrO₂ can also be used as catalyst supports.

Suitable catalysts 36A-36B for performing the present method are summarized in Table 1.

TABLE 1
(Catalysts 36A-36B)

| | Co-based catalyst | Fe-based catalyst |
|---|---|---|
| Catalyst major | Co | Fe |
| component | | |
| Supports | Al₂O₃ zeolites, SiO₂, ZrO₂, | Al₂O3, zeolites, SiO₂, |
| | TiO₂ | ZrO₂, TiO₂ |
| Promoters | Ru, Pt, K, Re, Cu, La, Zn, Fe | Zn, K, Cu, Ru, Co, La |

With respect to Step 16 (producing a non-thermal plasma in the reaction chamber to convert the methane gas and the reactant gas into radicals), this step can be performed by operation of the reactor 30A-30B (FIGS. 2A-2B). As used herein, a non-thermal plasma means a plasma in a gaseous media at near-ambient temperature. In contrast to a thermal plasma, a non-thermal plasma directs electrical energy, rather than thermal energy, to induce desired gas chemical reactions. In the present method, the chemical reactions are controlled to form CₓH_{y}* radicals which are then directed over the catalyst to couple into hydrocarbons in liquid form.

With respect to Step 18 (directing the radicals over the catalyst to couple the radicals into hydrocarbons in liquid form), this step can also be performed by operation of the reactor 30A-30B (FIGS. 2A-2B). The flow of the gases through the reactor 36A-36B (FIGS. 2A-2B), and the location of the catalyst 36A-36B (FIGS. 2A 2B) downstream of the plasma zone 40A-40B (FIGS. 2A-2B) insures that the radicals are directed over the catalyst 36A-36B (FIGS. 2A-2B). As the CₓH_{y}* radicals produced by the plasma can last several seconds, the CₓH_{y}* radicals can be coupled directly into higher hydrocarbons in liquid form on the catalyst surface. Exemplary hydrocarbons in liquid form include methanol, gasoline (C₅ to C₁₂) and diesel (over C₁₀ to C₁₅). Exemplary reactions, radicals and the resultant hydrocarbons are summarized in Table 2.

TABLE 2
Coupling Of Radicals Into Higher Hydrocarbons

CH₄ + e → CH₃* + H* + e
CH₃* + CH₃* → C₂H₆
C₂H₆ + e → C₂H₅* + H* + e
C₂H₅* + C₂H₅* → C₄H₁₀
C₄H₁₀ + e → C₄H₉* + H* + e
C₂H₅* + C₄H₉* → C₆H₁₄
C₂H₅* + CH₃* → C₃H₈
C₆H₁₄ + e → C₆H₁₃* + H* + e
C₆H₁₃* + C₄H₉* → C₁₀H₂₂
H₂O + e → OH* + H* + e
CH₃* + OH* → CH₃OH
C₂H₅* + OH* → C₂H₅OH
CH₃OH + e → CH₃O* + H* + e
CH₃* + CH₃O* → CH₃OCH₃

With respect to Step 20 (controlling production of the radicals and coupling of the radicals into the hydrocarbons by controlling the flow rates of the methane gas and the reactant gas, a forward power of the plasma, and a frequency of the plasma), the flow rates can be selected based on the size of the reactor 28A-28B (FIGS. 2A-2B). In addition, the flow rates can be selected to achieve a desired ratio of methane gas to reactant gas. Still further, the flow rates can be selected such that more methane gas is reacted to produce the CₓH_{y}* radicals. Methane slip refers to unreacted methane which passes through the reactor 28A-28B (FIGS. 2A-2B) without reacting. It is advantageous to have less methane slip.

Also with respect to Step 20 (controlling production of the radicals and coupling of the radicals into the hydrocarbons by controlling the flow rates of the methane gas and the reactant gas, a forward power of the plasma, and a frequency of the plasma), the forward power and the frequency can be controlled by control of the operating conditions of the reactor 28A-28B (FIGS. 2A-2B). In addition, these conditions can be controlled to provide an optimal average electron energy of the plasma. The average electron energy produced by the plasma is a key variable in the practice of the present method. By way of example, a microwave plasma reactor 28A (FIG. 2A) can produce an average electron energy of about 5 eV. A pulsed corona discharge plasma reactor 28B (FIG. 2B) can produce an average electron energy of about 9-10 eV. Flow rates and operating conditions of the reactor which can affect the average electron energy of the plasma are summarized in Table 3 for a catalyst packing zone of 5 to 100 ml.

TABLE 3
Reactor Operating Conditions

| Operating condition | Range | |
|---|---|---|
| Flow rate | 100-1000 | ml/min |
| Power | 100-1000 | W |
| Pressure | 10-2200 | mm Hg |
| Reactor size | 5-100 | ml |

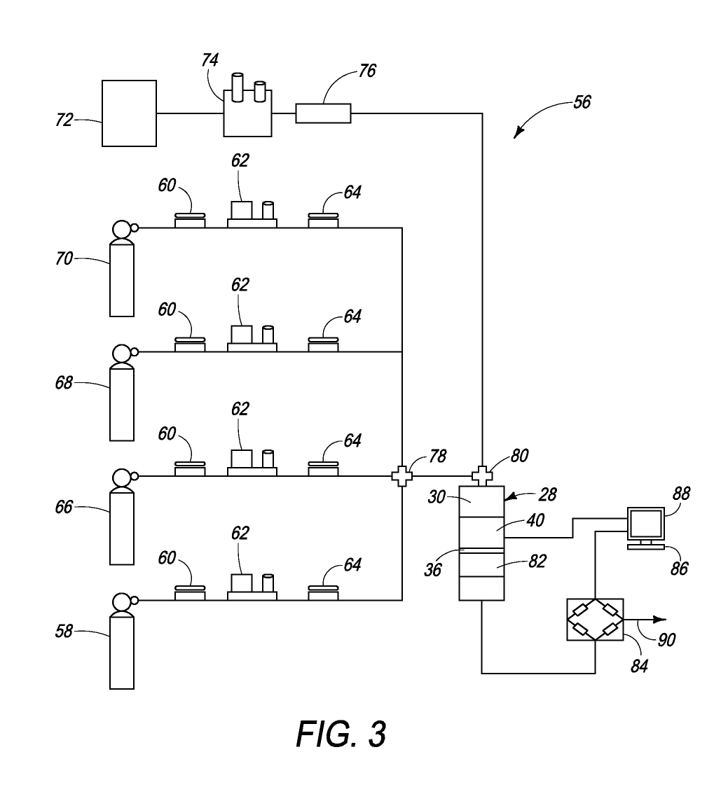

Referring to FIG. 3, a system 56 for converting a methane gas to a liquid fuel includes a CH₄ gas source 58 configured to provide a methane gas flow. The CH₄ gas source 58 is in flow communication with a mass flow controller 62 connected to an upstream ball valve 60 and a downstream ball valve 64. The system 56 also includes a CO₂ gas source 66, an 02 gas source 68, and an inert gas (Ar) source 70, each of which is in flow communication with a mass flow controller 62 and ball valves 60, 64. The CH₄ gas source 62, the CO₂ gas source 66, the O₂ gas source 68, and the inert gas (Ar) source 70 are also in flow communication with a first union 78 configured to mix the gases.

The system 56 also includes an H₂O source 72 connected to a measuring pump 74 and a steam generator 76. The system 56 also includes a second union 80 configured to mix the flow of gases from the CH₄ gas source 62, the CO₂ gas source 66, the O₂ gas source 68, and the inert gas (Ar) source 70 with the steam flow generated by the steam generator 76.

The system 56 also includes a reactor 28 having a reaction chamber 30 with a plasma zone 40 configured to generate a non-thermal plasma and radicals, and a catalyst zone 82 containing a catalyst 36. The reactor 28 can comprise a microwave plasma reactor 28A (FIG. 2A) or a pulsed corona discharge plasma reactor 28B (FIG. 2B) as previously described. The system 56 also includes a gas chromatograph 84 configured to analyze the products 90 produced by the reactor 28. The system 56 also includes a computer 86 and associated monitor 88 configured to on-line demonstrate the results from the gas chromatograph 84.

Thus the disclosure describes an improved method and system for converting a methane gas to a liquid fuel. While the description has been with reference to certain preferred embodiments, as will be apparent to those skilled in the art, certain changes and modifications can be made without departing from the scope of the following claims.

What is claimed is:

1. A method for converting a methane gas to a liquid fuel comprising:
providing a reactor having a reaction chamber;
providing a flow of methane gas and a flow of a reactant gas into the reaction chamber;
providing a catalyst in the reaction chamber;
producing a non-thermal plasma in the reaction chamber to convert the methane gas and the reactant gas into radicals; and
directing the radicals over the catalyst to couple the radicals into hydrocarbons in liquid form.

2. The method of claim 1 further comprising controlling production of the radicals and coupling of the radicals into the hydrocarbons by controlling the flow rate of the methane gas, the flow rate of the reactant gas, a forward power of the plasma, and a frequency of the plasma.

3. The method of claim 1 wherein the providing the catalyst step comprises selecting, preparing and dispersing the catalyst to optimize the production of the radicals.

4. The method of claim 1 wherein the reactor comprises a microwave plasma reactor or a pulsed corona discharge plasma reactor.

5. The method of claim 1 wherein the methane gas comprises natural gas or bio gas.

6. The method of claim 1 wherein the radicals comprise CₓH_{y}* radicals.

7. The method of claim 1 wherein the liquid fuel comprises methanol, gasoline (C₅ to C₁₂) or diesel (over C₁₀ to C₁₅).

8. The method of claim 1 wherein the flow of the reactant gas comprises CO₂, O₂ and H₂O.

9. The method of claim 1 wherein the catalyst comprises a Co-based catalyst or an Fe-based catalyst.

10. A method for converting a methane gas to a liquid fuel comprising:
providing a reactor having a reaction chamber;
providing a flow of a methane gas and a flow of reactant gas into the reaction chamber, the reactant gas comprising CO₂, H₂O, O₂ or combinations thereof with the flow of the methane gas and the flow of the reactant gas in a ratio selected to provide the liquid fuel with a desired chemical composition;
providing a catalyst in the reaction chamber comprising a Co-based catalyst or an Fe-based catalyst;
producing a non-thermal plasma in the reaction chamber to convert the methane gas and the reactant gas into selected CₓH_{y}* radicals;
directing the radicals over the catalyst to couple the radicals into hydrocarbons in liquid form; and
controlling production of the radicals and coupling of the radicals into the hydrocarbons by controlling the flow rate of the methane gas, the flow rate of the reactant gas, a forward power of the plasma, and a frequency of the plasma.

11. The method of claim 9 further comprising following the directing step, recycling unreacted gases back into the reaction chamber.

12. The method of claim 9 wherein the flow of the methane gas and the flow of the reactant gas are combined in a ratio to provide the liquid fuel in the form of methanol, gasoline (C₅ to C₁₂) or diesel (over C₁₀ to C₁₅).

13. The method of claim 9 wherein a combined flow rate of the methane gas and the reactant gas is from 100-1000 ml/min.

14. The method of claim 9 wherein the power is from 100-1000 Watts.

15. The method of claim 9 wherein a pressure in the reaction chamber is from 10-2200 mm Hg.

16. A system for converting a methane gas to a liquid fuel comprising:
a methane gas source configured to provide a methane gas flow;
a reactant gas source configured to provide a reactant gas flow;
a reactor connected to the methane gas source and the reactant gas source configured to form a non-thermal plasma and produce radicals; and
a catalyst configured to contact the radicals to produce reactions for coupling the radicals into hydrocarbons in liquid form.

17. The system of claim 16 wherein the reactor comprises a microwave plasma reactor or a pulsed corona discharge plasma reactor.

18. The system of claim 17 wherein the methane gas comprises natural gas or bio gas.

19. The system of claim 18 wherein the reactant gas comprises CO₂, H₂O, O₂ and combinations thereof with the flow of the methane gas and the flow of the reactant gas in a ratio selected to provide the liquid fuel with a desired chemical composition.

20. The system of claim 19 wherein the radicals comprise CₓH_{y}* radicals.

21. The system of claim 20 wherein the catalyst comprises a Co-based catalyst or an Fe-based catalyst.
